(19) United States
(12) Patent Application Publication
(10) Pub. No.: US 2009/0177489 A1
(43) Pub. Date: Jul. 9, 2009

(54) SYSTEMS AND METHODS FOR PATIENT SCHEDULING AND RECORD HANDLING

(75) Inventors: Pedro Martinez, Boca Raton, FL (US); Noel Guillama, Wellington, FL (US)

Correspondence Address: AKERMAN SENTERFITT, P.O. BOX 3188, WEST PALM BEACH, FL, 33402-3188, US

(73) Assignee: The Quantum Group, Inc., Wellington, FL (US)

(21) Appl. No.: 12/349,738

(22) Filed: Jan. 7, 2009

Related U.S. Application Data
(60) Provisional application No. 61/019,514, filed on Jan. 7, 2008.

(51) Int. Cl. G06Q 50/00; G06Q 40/00

(52) U.S. Cl. 705/2; 705/40

(57) ABSTRACT

A computer automated tool is provided, the tool being designed to coordinate the complex processes of patient scheduling and record handling. The tool and supporting methods intelligently input, correlate, notify and link schedules to medical records and patient-specific scheduling behavior.

### CROSS-REFERENCE TO RELATED APPLICATIONS

This application claims the benefit of U.S. Provisional Patent Application No. 61/019,514, which was filed Jan. 7, 2008, and which is incorporated herein in its entirety.

### FIELD OF THE INVENTION

The present invention is related to the field of data processing, and more particularly, to systems and methods for scheduling and record handling, particularly in the context of healthcare management.

### BACKGROUND OF THE INVENTION

The seemingly ever-rising costs of healthcare has prompted considerable concern not only among patients but healthcare providers and insurers alike. An often overlooked source of the considerable costs associated with patient care is the cost of scheduling treatment, whether in the context of patients' visits to a doctor's office or treatment of patients at a hospital or out-patient facility. The complex nature of modern medical treatment involves not merely scheduling a visit or treatment, itself on often complicated task, but also handling various associated records such as medical history files and insurance files. Given that conventional techniques for scheduling and record handling are typically performed manually and usually very labor intensive, the mere scheduling and record handling aspect of medical treatment can significantly contribute to the costs of providing healthcare.

Another important consideration is the fact that time out of work is one of the most significant items pertaining to the costs associated with healthcare. Reducing this time through efficient and effective methods for reducing time waiting, for example, at a doctor's office can substantially mitigate costs and enhance productivity in the economy as less time is lost for any particular healthcare-related activity.

Accordingly, there is a need for more effective and efficient means of patient scheduling and record handling. More particularly, there is a need for effective and efficient systems and methods to receive, record, and update patient-specific data and to link that data with medical and other files in the context of patient scheduling

### SUMMARY OF THE INVENTION

The present invention is directed to computer-based automated tools and related methods for coordinating the complex processes involved in patient scheduling and record handling. One aspect of the invention is the ability to dynamically optimize complex scheduling processes with related patient-specific information, such as medical records, scheduling preferences, payment history, and insurer information. Another aspect of the invention is to provide real-time alerts and links to related information.

One object of the invention is to provide Online appointment scheduling by a patient and healthcare provider (preferably, via a two-way communication link, to provider schedule management—including, for example, automated record entry, cancellations, modifications, optimization and pertinent scheduling analysis—and to provide personalization and optimization of the patient's and/or healthcare provider's preferences. Another object of the invention is to provide links to the patient's health records for intelligent scheduling and supporting documentation, to provide links to the patient's schedule and cancellation history, and to permit intelligent creation of a patient schedule rating, which can grade a patient's schedule adherence history.

Still another object of the invention is to provide links to the patient's payment record, to provide automatic electronic alerts to the patient and healthcare provider of pending consultation and/or changes. Yet another object of the invention is to relate patient scheduling to a healthcare provider's cash flow based on payment method, whether the patient is a “self pay,” Medicare or Medicaid recipient, or has private insurance. Another object of the invention is to provide individual patient profiles based on treatment interaction type and form of payment for scheduling optimization and to link relevant information to the scheduling of related services such as MRIs, labs, therapy, or other medical service.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1A is a schematic view of an exemplary environment in which a system, according to one embodiment of the invention, can be utilized.

FIG. 1B is a schematic view of the system shown in FIG. 1A, according to one embodiment of the invention.

FIG. 2 is a schematic view of certain operative features of the system shown in FIG. 1A.

### DETAILED DESCRIPTION

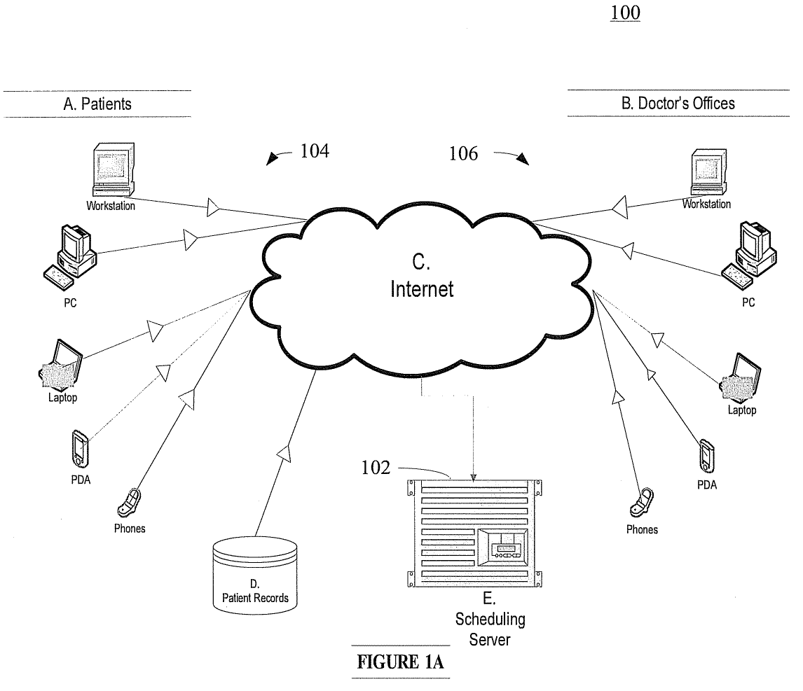

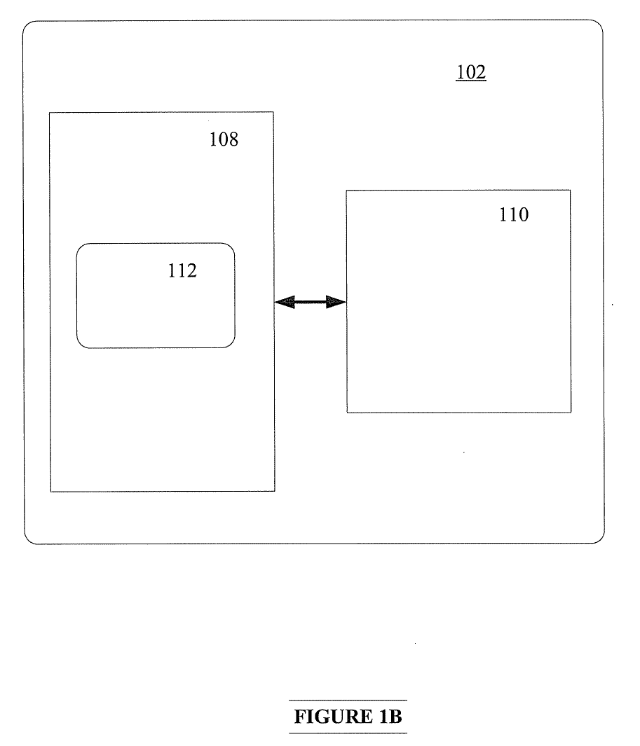

FIG. 1A provides a schematic view of an exemplary environment 100 in which a system 102, according to one embodiment of the invention, can be utilized. The exemplary environment illustratively includes a plurality of computing and/or communication devices 104 used by patients to access the system 102 via a communications network. Additionally, the exemplary environment illustratively includes a plurality of computing and/or communication devices 104 used by healthcare providers to also access the system 102 via the communications network. The system 102, described more particularly below, is an automated scheduling system that enables patients to schedule activities, such as visits to a physicians office, treatments at a hospital or out-patient clinic, or schedule any other type of service provided by various types of healthcare providers.

Accordingly, as shown, patients (A) can use any of variety of electronic devices to input or access the scheduling system 102. Such devices can include personal computers, laptops, PDAs, smart phones and regular phones. As also shown, at healthcare provided site, such as the illustrated doctor's offices (B), an equal variety of devices are available to physicians and their office personnel to input, monitor, and access the scheduling system 102, including electronic medical tablet computers. Universal connectivity is provided via the internet (C). This allows access to the Scheduling System in a virtual and ubiquitous manner, whether wired or wireless.

Via the network, one or more databases that store the wide variety of patient records (D) can be accessed from multiple sources (e.g., hospitals, doctors' offices, labs and imaging centers). As shown, the scheduling system 102, can be implemented as a network-connected server (E), which provides the accessing functionality of multiple, disparate electronic scheduling software, a uniform method for scheduling transactions and that can include access to schedules in order to view, update or modify scheduled activities, as well as provide automatic alerts, analysis, reporting and intelligent links to patient records, payment history and preferences.

Referring additionally to FIG. 1B, a more detailed schematic view of the system 102 is provided. The system 102 illustratively includes at least one electronic data processor 108, a network interface 110, and a scheduling module 112. The network interface 110 is connected with the processor 108 to communicatively link the processor with the one or more databases on which electronic data is stored. The scheduling module 112, if implemented as computer-readable code, is configured to execute on the processor 108 as provide two-way scheduling for a patient and a healthcare provider.

The scheduling module 112 can be further configured to receive and record patient data supplied via the network interface, cancel a scheduled activity in response to input from the patient or healthcare provider, and/or modify a scheduled activity in response to input from the patient or healthcare provider. The scheduling module 112 also can be further configured to optimize scheduling of multiple activities for multiple patients based on inputs received from the multiple patients, the optimization being performed subject to preference constraints set by at least one healthcare provider. Additionally, or alternatively, the scheduling module 112 can be further configured to receive scheduling preferences from at least one patient or from at least one healthcare provider and to perform the optimization subject to the received scheduling preferences.

According to still another embodiment, the scheduling module 112 can be further configured to link via the network interface 110 to the at least one database for obtaining patient-specific records stored thereon in response to scheduling an activity for at least one patient associated with the patient-specific records. The patient-specific records can include a cancellation or schedule adherence history of the at least one patient, for example.

According to yet another embodiment, the scheduling module 112 can be further configured to provide a schedule rating corresponding to the at least one patient based upon the cancellation or schedule adherence history of the at least one patient. The patient-specific records, alternatively or additionally, can include a payment record corresponding to the at least one patient.

The scheduling module also can be configured to relate a scheduled activity for the patient to cash flow based upon a method of payment by the patient. This method of payment can indicate whether the patient is a “self-pay,” privately insured patient, or a Medicare or Medicaid recipient. Accordingly, the scheduling module 112 can be configured to provide patient-specific profiles correlating treatment interaction type with forms of payment and to optimize scheduling for the healthcare provider based upon the correlation. Additionally, the scheduling module 112 can be further configured to link scheduled activities for a patient with related services. Such services can include, for example, a medical diagnostic procedure (e.g., MRI scan or lab workup) or any various types medical treatment (e.g., surgery or physical therapy).

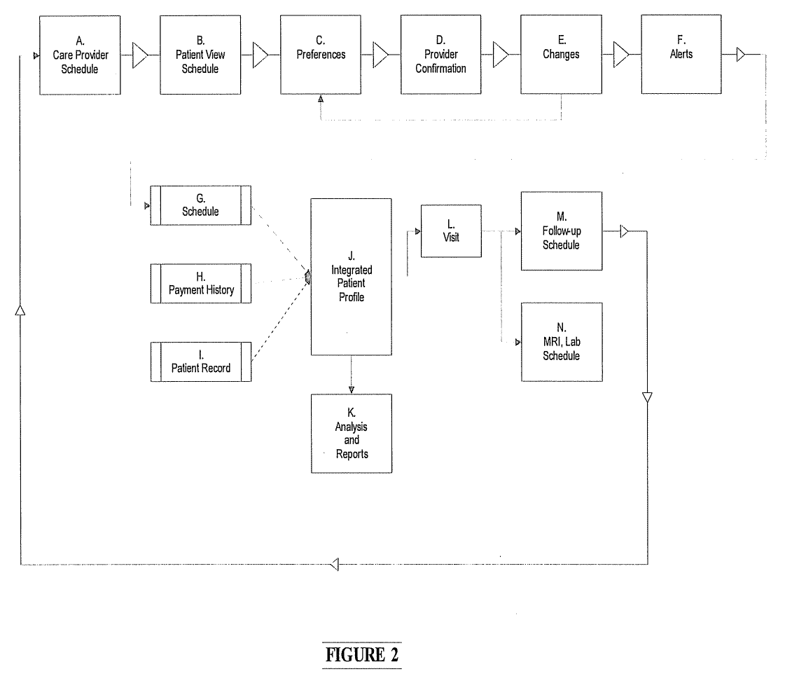

FIG. 2 illustrates some of the operative functions that can be performed based on the various configurations of the scheduling system 102. Illustratively, a representative healthcare providers schedule (A) is accessed by a patient (B). The patient's and healthcare provider's preferences (C) are identified and stored for future reference. The healthcare provider subsequently confirms the scheduled appointment (D). If any subsequent changes (E) are made, the changes can be re-integrated into the schedule. Accordingly alerts and/or reminders (F) can be automatically sent to one or both the healthcare provider and the patient (or a member of the patient's family or other responsible person, as required).

The schedule (G), payment history (H) and patient record (I) also can be integrated at one or more healthcare provider workstations (J), which can access the system 102 via the communications network as described above. Additionally, analysis and reports (K) can be generated so as to provide intelligence, measurements and projections about scheduling trends. The patient then undergoes the scheduled activity (e.g., visits (L) the healthcare provider. Follow-up visits (M) and/or the scheduling of related services such as MRIs or laboratory work (N) also can be scheduled, as needed. Upon completion of this last step, the process can be repeated for another patient.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-based system for patient scheduling and record handling, the system comprising:
at least one electronic data processor;
a network interface connected with the processor for communicatively linking the processor with at least one database for storing electronic data; and
a scheduling module configured to execute on the processor for providing two-way scheduling for a patient and a healthcare provider.

2. The system of claim 1, wherein the scheduling module is further configured to perform at least one among receiving and recording patient data supplied via the network interface, canceling a scheduled activity in response to input from the patient or healthcare provider, and to modify a scheduled activity in response to input from the patient or healthcare provider.

3. The system of claim 2, wherein the scheduling module is further configured to optimize scheduling of multiple activities for multiple patients based on inputs received from the multiple patients, the optimization being performed subject to preference constraints set by at least one healthcare provider.

4. The system of claim 2, wherein the scheduling module is further configured to receive scheduling preferences from at least one patient or at least one healthcare provider and perform the optimization subject to the received scheduling preferences.

5. The system of claim 1, wherein the scheduling module is further configured to link via the network interface to the at least one database for obtaining patient-specific records stored thereon in response to scheduling an activity for at least one patient associated with the patient-specific records.

6. The system of claim 5, wherein the patient-specific records comprise a cancellation or schedule adherence history of the at least one patient.

7. The system of claim 6, wherein the scheduling module is further configured to provide a schedule rating corresponding to the at least one patient based upon the cancellation or schedule adherence history of the at least one patient.

8. The system of claim 5, wherein the patient-specific records comprise a payment record corresponding to the at least one patient.

9. The system of claim 1, wherein the scheduling module is further configured to relate a scheduled activity for the patient to cash flow based upon a method of payment by the patient.

10. The system of claim 1, wherein the scheduling module is further configured to provide patient-specific profiles correlating treatment interaction type with forms of payment and to optimize scheduling for the healthcare provider based upon the correlation.

11. The system of claim 1, wherein the scheduling module is further configured to link scheduled activities for a patient with related services.

12. The system of claim 11, wherein the related services comprise at least one among a medical diagnostic procedure and a medical treatment.

13. A computer-based method of patient scheduling and record handling, the method comprising:
providing a patient access to an electronically stored schedule corresponding to a healthcare provider;
determining a time to schedule the patient for a patient-requested activity, wherein the determination is made by performing an optimization procedure subject to at least one constraint specified by the patient or the healthcare provider; and
confirming the schedule to the patient.

14. The method of claim 13, further comprising storing in an electronic database at least one of a patient-specified scheduling preference and a healthcare provider preference.

15. The method of claim 13, further comprising revising the time to schedule the patient for a patient-requested activity and notifying at least one of the patient and the healthcare provider of the revision.

16. The method of claim 13, further comprising automatically notifying at least one of the patient and the healthcare provider of a scheduled activity in advance of the time the activity is scheduled.

17. The method of claim 13, further comprising linking the patient to at least one of a patient payment history and a payment record in advance of determining the time.

18. The method of claim 13, further comprising subsequently correlating the time to an additional activity, wherein the additional activity comprises at least one among a medical diagnostic procedure and a medical treatment

19. The method of claim 13, generating at least one analysis and corresponding report based upon scheduling activity.

20. The method of claim 19, wherein the analysis and corresponding report provide a projection of scheduling trends.
